(19) United States
(12) Patent Application Publication
(10) Pub. No.: US 2008/0142670 A1
(43) Pub. Date: Jun. 19, 2008

(54) Devices, systems, and methods for mounting components

(76) Inventors: Randall S. Cvelbar, Columbus, IN (US); Troy A. Iler, Salem, OH (US); Jon C. Hobbs, Alabaster, AL (US)

Correspondence Address: DELPHI TECHNOLOGIES, INC., M/C 480-410-202, PO BOX 5052, TROY, MI, 48007, US

(21) Appl. No.: 11/638,033

(22) Filed: Dec. 13, 2006

(51) Int. Cl. F16M 13/00

(52) U.S. Cl. 248/544

(57) ABSTRACT

Embodiments of the invention comprise devices, systems, and methods for mounting a component on a surface, including without limitation, mounting preassembled components to any surface of an assembled product. In some embodiments, the invention comprises a moveable locking retainer for mounting the component, comprised of a shaft; a head with a plurality of arms, each arm having an engagement finger and an engagement shoulder that form an engagement gap which engages the edge of a corresponding opening in the surface. The locking retainer also comprises a base with engagement prongs that prevent the locking retainer from being removed from a corresponding locking receptacle on the component, once attached. Other embodiments are also disclosed and claimed.

### BACKGROUND

Today, the vast majority of consumer products are produced by mass production. In these production techniques, components of the ultimate product are often made or assembled in advance, shipped to the production line, and combined with other components to form the complete consumer product, often while the production line continues to move. In order to maintain sufficient continuity of production, and to prevent and/or minimize production delays or shutdowns, components often must be designed so as to facilitate not only their assembly and ultimate functionality, but also their repair and/or replacement.

As one example only, motor vehicle production relies heavily on the installation of preassembled component parts, such as electrical components. For example, an electrical component, such as an alternator or a wiper motor for an automobile, may be preassembled in a remote location and subsequently delivered to an assembly work station on a production line, where a worker or automated means may install the component into a partially assembled motor vehicle, and from which work station, the vehicle under assembly may continue down the production line to the next work station.

It should be appreciated that such components may be configured to attach or mount on surfaces on or within the motor vehicle. As one example only, a typical jump start fuse block may be configured to attach to a section of rigid sheet material (e.g., sheet metal), for example an inner fender wall or a firewall of a motor vehicle. In such cases, the means for attaching the component attachment may comprise brackets that contain locks that are integral to the fuse block housing. The locks may insert into corresponding slots or openings in the sheet material, and the component may slide toward the surface so that the locks may engage an internal surface of the sheet material.

Unfortunately, a number of difficulties may be encountered during assembly of such locking/mounting brackets. For example, a bracket or its lock may become damaged or break off. In such circumstances, the broken or damaged bracket or lock must be repaired or replaced, thus slowing production or resulting in a time-consuming re-work at the vehicle assembly plant. In addition, although integral locks reduce the overall number of parts associated with a component, common casting techniques often prefer that the material from which the locks are formed comprises the same material as the component housing. Thus, integral locks may not cost-effectively permit the use of more desirable lock materials and may complicate the re-work process. In the case of more complex parts, such as fuse block assemblies, components containing electronic circuitry, and the like, the costs associated with repair or replacement of the damaged part are increased, since the components have already been subject to significant fabrication or assembly before attachment to the vehicle. In addition, even where a substitute component is made available, due to the sunk costs in the existing component, it is often desirable to re-work the component for use in another assembled product.

Thus, a significant need remains for devices and systems that facilitate installation, repair, or replacement of components, either during assembly or after sale of the ultimate product.

### SUMMARY OF THE INVENTION

In an exemplary embodiment, a locking retainer for mounting a component to a surface comprises a shaft, a head attached to a distal portion of the shaft, and a base formed at a more proximal portion of the shaft. In accordance with this embodiment, the base comprises a plurality of engagement prongs on its lateral sides, and the head comprises a plurality of arms that extend outwardly from the longitudinal axis of the shaft, each arm comprising an engagement finger and an engagement shoulder that form an engagement gap. In addition, the engagement gap of each arm is configured to engage the edges of an opening in the surface and wherein the engagement prongs are configured to engage a locking receptacle on the component. It should be appreciated that the component may be a preassembled component configured for assembly into a consumer product such as a motor vehicle, and the surface to which the component is to be mounted may be a surface in or on a motor vehicle, such as an inner fender wall, a firewall, or a housing of another pre-assembled component. Moreover, the component may be an electrical component.

In an exemplary embodiment, the locking retainer may also comprise one or more slots along its longitudinal axis. Additionally, one of the slots may be configured to interface with a guide ridge on the component. Alternatively, the component may comprise one or more guide ridges that interface with a respective slot on the locking retainer.

In an exemplary embodiment, a system for mounting a component to a surface comprises a pre-assembled component that includes at least one locking receptacle and at least one mounting bracket with an engagement tang, a locking retainer, and a surface with at least one opening configured to accept the mounting bracket and the locking retainer. In accordance with this embodiment, the locking retainer is inserted into the locking receptacle on the component and has a shaft. In addition, a head is attached to a distal portion of the shaft and has a plurality of arms that extend outwardly from the longitudinal axis of the shaft, each arm comprising an engagement finger and an engagement shoulder that form an engagement gap. A base is formed at a more proximal portion of the shaft and has a plurality of engagement prongs on its lateral sides. The mounting bracket is inserted into the opening in the surface, the component is moved so as to engage the engagement tang with the surface, and the locking receptacle is inserted into the opening so that the edge of the opening is engaged in the engagement gaps of the locking retainer. Finally, the engagement prongs on the locking retainer are engageable with the locking receptacle to prevent removal of the locking retainer from the locking receptacle.

In an exemplary embodiment, a method of mounting a component to a surface comprises the steps of providing a component having at least one locking receptacle and at least one mounting bracket with an engagement tang, providing a locking retainer that is insertable into the locking receptacle on the component, inserting the locking retainer into the locking receptacle, providing a surface with at least one opening configured to accept the mounting bracket and the locking retainer, inserting the mounting bracket into the opening in the surface, moving the component so as to engage the engagement tang with the innermost side of the surface; and advancing the locking retainer into the opening until the edge of the opening is engaged in the engagement gap of the locking retainer. In accordance with this embodiment, the locking retainer includes a shaft, a head attached to a distal portion of the shaft, and a plurality of arms that extend outwardly from the longitudinal axis of the shaft, and a base formed at a more proximal portion of the shaft and having a plurality of engagement prongs on its lateral sides. In this embodiment, each arm comprises an engagement finger and an engagement shoulder that form an engagement gap. The engagement prongs on the locking retainer are engageable with the locking receptacle to prevent removal of the locking retainer from the locking receptacle.

### BRIEF DESCRIPTION OF THE DRAWINGS

FIG. 1 is an angled back view of a component configured in accordance with one embodiment of the present invention.

FIG. 2 is an angled top view of a component configured in accordance with one embodiment of the invention.

FIG. 3 is a top view of a component configured in accordance with one embodiment of the present invention.

FIG. 4 is a side view of a component configured in accordance with one embodiment of the invention, showing locking features.

FIG. 5 is a cutaway representation of a mounting surface to which a component may be attached.

FIG. 6 is an angled top view of a component in accordance with one embodiment, with its cover removed.

FIG. 7 is a horizontal view of a locking retainer in accordance with one embodiment of the invention.

FIG. 8 is an angled vertical view of a locking retainer in accordance with one embodiment of the invention.

FIGS. 9, 10, and 11 are, respectively, a side view, proximal end view, and distal end view of one embodiment of a locking retainer.

FIG. 12 is a side cutaway representation of a component attached to a surface in accordance with some embodiments of the invention.

### DETAILED DESCRIPTION

Embodiments of the invention meet the unmet need in the art by comprising novel devices, systems, and methods for mounting a component on a surface, including without limitation, mounting components to any surface of an assembled product.

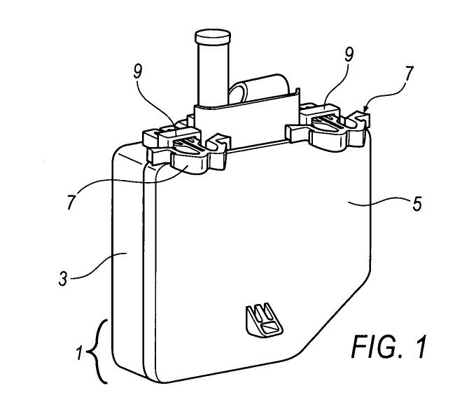

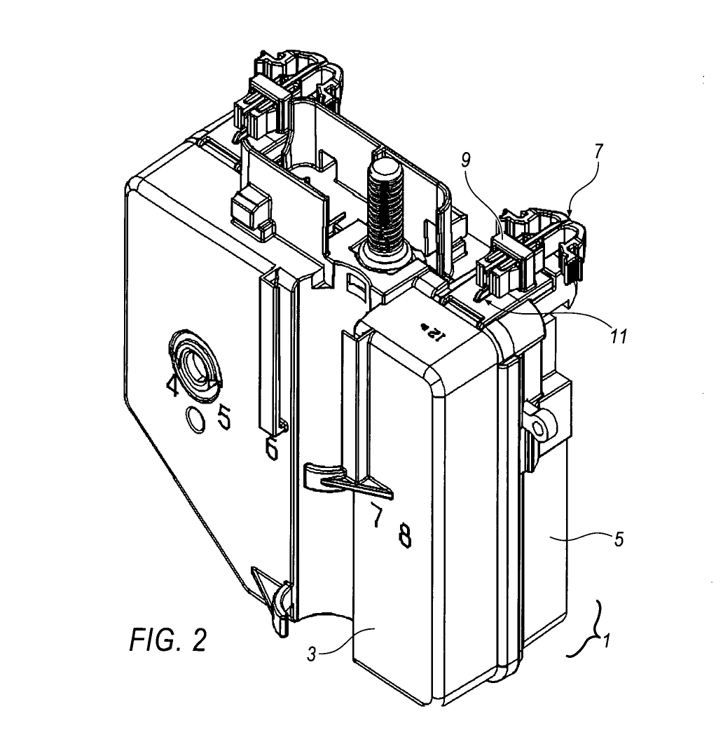

In some embodiments, the invention comprises a component 1 for attachment to a surface (FIGS. 1 and 2). The component 1 comprises one or more removable locking retainers 7 that are insertable into corresponding locking receptacles 9 that are attached or integral to the component 1 or its subparts, such as a cover 3, a housing 5, or the like.

The proximal end of locking retainer 7 and the inner cavity of locking receptacle 9 have corresponding shapes and are dimensioned so that the proximal end of locking retainer 7 is insertable and movable within the inner cavity of locking receptacle 9. The shape of the proximal end of locking retainer 7 and the inner cavity of the locking receptacle can be any shape, although a rectangular shape is preferred. In some embodiments, the proximal end of locking retainer 7 is snap-fitted through the inner cavity of locking receptacle 9, and a side of locking retainer 7 interfaces with a guide ridge 11 formed on the surface of component 1. Locking retainer 7 is movable laterally along its longitudinal axis within locking receptacle 9 and along guide ridge 11, if it is used.

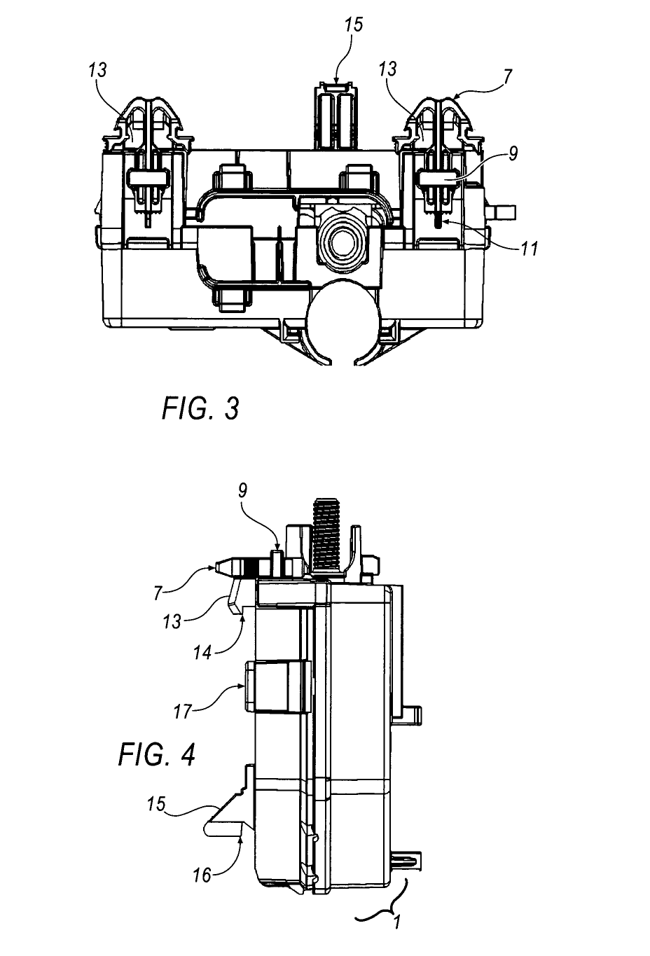

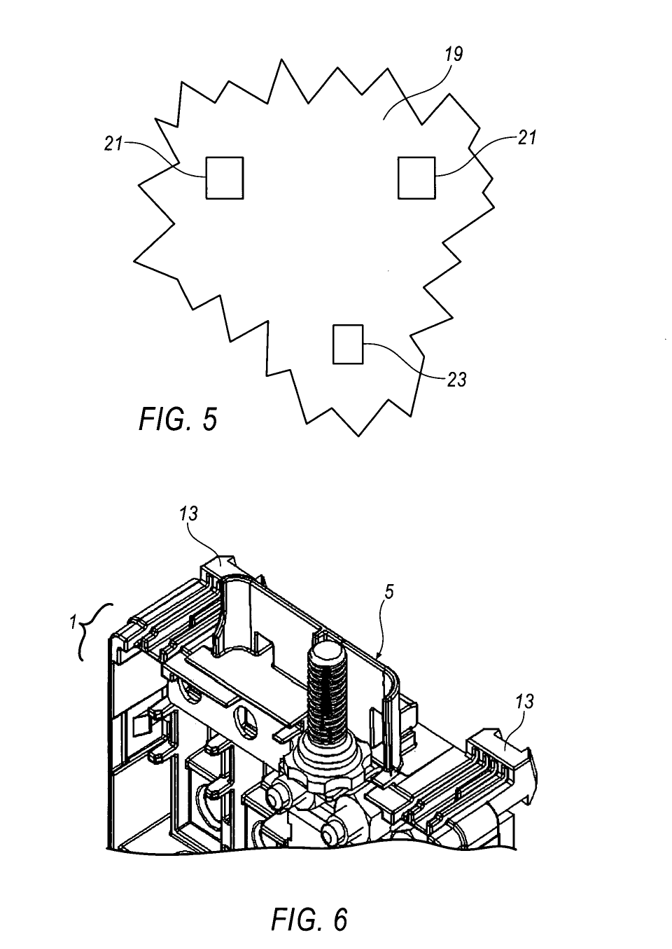

In some embodiments, the component 1 also includes one or more upper mounting brackets 13 and one or more lower mounting brackets 15 (e.g., FIGS. 3, 4, and 6). Upper mounting brackets 13 and lower mounting bracket 15 are configured and dimensioned to be insertable into respective corresponding openings in a mounting surface. FIG. 5 is a representation of a facing view of a mounting surface 19. Openings 21 in the surface 19 correspond and interface during installation with upper mounting brackets 13. In similar fashion, opening 23 interfaces and corresponds with lower mounting bracket 15. In some embodiments, one or more of the mounting brackets 13 and/or 15 are further comprised of a latching tang 14, 16 extending downwardly from the respective mounting bracket. The component may also comprise a raised surface 17 that opposes and contacts the mounting surface. In use, mounting brackets 13 and 15 are inserted into corresponding openings in the mounting surface until the innermost surface of the latching tang 14, 16 has cleared the innermost edge of the mounting surface. The component 1 is then pushed downwardly so that the width of the mounting surface is engaged by the latching tang. Contact between the inner surfaces of the latching tangs 14, 16 and the corresponding surface of the mounting surface, and between raised surface 17 and the mounting surface, results in opposing force sufficient to reduce movement and vibration of the component 1 during use of the final product.

In some embodiments, locking retainer 7 is inserted within locking receptacle 9 before mounting brackets 13 and 15 are inserted into the corresponding openings of mounting surface 19. In typical use, locking retainer 7 is movable and may be slid inwardly so that the distal end of locking retainer 7 does not impede the insertion of mounting bracket 13 into the corresponding opening 21 in the mounting surface 19. Opening 21 is shaped and dimensioned so that once mounting brackets 13 and 15 are inserted into their corresponding openings, the distal end of locking retainer 7 can be advanced through the remaining portion of opening 21 and snap-fit into place by application of force to its proximal end. So configured, locking retainer 7 locks to the edge of the opening 21 in the mounting surface 19 and blocks upper mounting bracket 13 from moving upwardly and thereby unlatching the component 1 from the mounting surface 19.

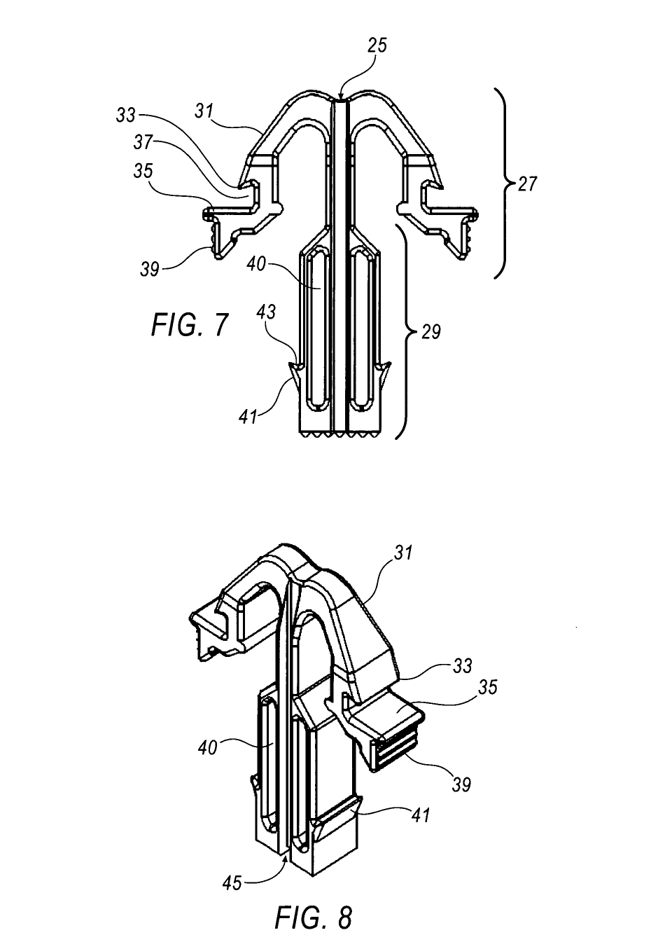

FIGS. 7-8 are, respectively, a horizontal view and an angled vertical view of an embodiment of locking retainer 7. Locking retainer 7 is comprised of 3 parts: a shaft 25 forming a longitudinal axis; a head 27 at more distal portion of locking retainer 7; and a base 29 at a more proximal portion. Head 27 is comprised of a plurality of arms 31 which are attached or formed at a distal end of shaft 25 and extend outwardly from the longitudinal axis and proximally toward base 29. At the most distal end of locking retainer 7, head 27 has a width across arms 31 that is narrower than the corresponding opening in the intended mounting surface. Moving proximally from the distal tip of locking retainer 7, arms 31 continue to extend out laterally, either in linear fashion, arcuate fashion, or any single or combination of design, so that the width of head 27 across arms 31 eventually exceeds the width of the corresponding opening of the intended mounting surface at the line measured between points of engagement fingers 33 of head 27. Arms 31 are formed of either any metal, plastic, or other material which is sufficiently strong for the intended use yet is resilient, elastic, and capable of biasing. Although any suitable material known to those of ordinary skill may be used, impact modified polypropylene is preferred. Locking retainer 7 may be formed by injection molding or by any other suitable technique known to those of ordinary skill in the art.

Each arm 31 is further configured to comprises a latch including engagement finger 33, latching gap 37, and engagement shoulder 35 so that when head 27 is inserted into the corresponding opening in the intended mounting surface, arms 31 are biased inwardly until head 27 is inserted sufficiently so that engagement fingers 33 have passed through the width of the mounting surface. At that point, arms 31 return to their original position due to the elasticity of the material used in their construction so that the mounting surface becomes entrained in the latching gaps 37 between engagement fingers 33 and engagement shoulders 35. In some embodiments, engagement fingers 33 are designed to angle inwardly toward the innermost surface of mounting surface, thus further preventing retraction of the head 27, once inserted.

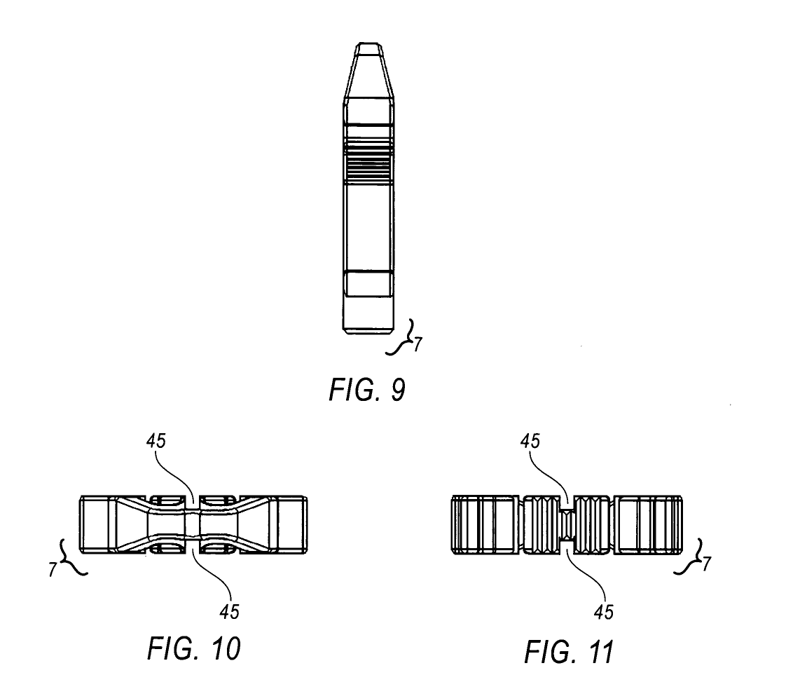

FIGS. 9, 10, and 11 are, respectively, a side view, a distal view, and proximal view of one embodiment of a locking retainer 7. As shown in FIGS. 9-10, the head of the locking retainer 7 may be tapered at the user's option to facilitate insertion into the mounting surface. Also at the user's option, the proximal end of the locking retainer may have gripping threads to facilitate use, as shown in FIG. 11. Locking retainer 7 may also have one or more slots 45 along its longitudinal axis that interface with guide ridge 11 on component 1.

Should the user wish to remove locking retainer 7 from the mounting surface, the user may apply force inwardly to actuating members 39 toward the longitudinal axis 25 of head 27. By doing so, arms 31 are biased inwardly so that the width of head 27 across the line formed by the outermost points of engagement fingers 33 is decreased until that width is less than the width of the corresponding opening in the mounting surface. Once this width is reached, the user may retract locking retainer 7 from the opening in the mounting surface, thereby removing locking retainer 7 from the corresponding opening.

In analogous fashion, base 29 of locking retainer 7 has a lateral width at its most proximal end that is less than the width of the inner cavity of corresponding locking receptacle 9. In some embodiments, base 29 is formed with a plurality of oblong spaces 40 between the outer edge of base 29 and the shaft 25. Moving distally from the most proximal end of base 29, the width of base 29 slopes outwardly to form engagement prongs 41 that extend laterally from base 29. Distal to engagement prongs 41, the width of base 29 is again less than the width of the inner cavity of locking receptacle 9. Locking receptacle 9 is formed of metal, plastic, or any other material which is sufficiently strong for the intended use yet is resilient, elastic, and capable of biasing. Although any suitable material known to those of ordinary skill may be used, thermoplastic molding compound Nylon 6/6, which is glass filled 14%, impact modified, and heat stabilized, is preferred. Base 29 is configured so that when locking retainer 7 is snap-fitted into locking receptacle 9, engagement prongs 41 travel slidably through locking receptacle 9 at least to the point where engagement prongs 41 have passed the inner edge of locking receptacle 9. The passage of engagement prongs 41 through locking receptacle 9 is accommodated by elasticity of the edges of the base 29 due to the material used in its construction and/or flexibility embued to the associated outer edges due to the oblong spaces 40. So configured, engagement points 41 prevent retraction of locking retainer 7 outwardly through locking receptacle 9 by abutting against the innermost edge of locking receptacle 9.

The user may determine suitable dimensions of the component 1 and its associated features, locking retainer 7, mounting bracket 9, openings in the mounting surface, and the like in accordance with the desired application and according to methods known to those of ordinary skill in the art.

### EXAMPLE

The following example of one embodiment of the invention is provided without limiting the invention to only those embodiments described herein.

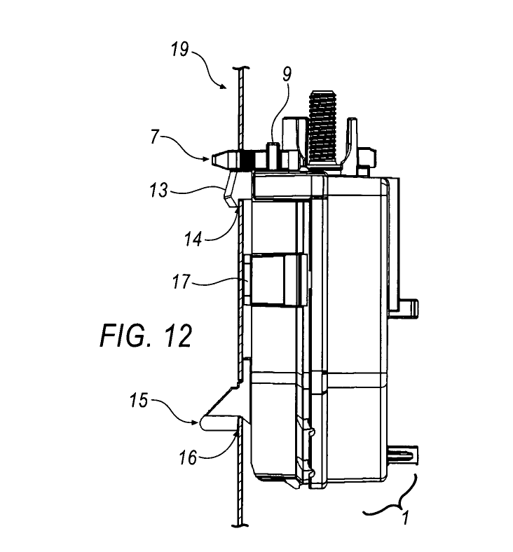

FIG. 12 shows a cutaway view of a system for mounting a component on a surface of a motor vehicle in accordance with some aspects of the invention. A fuse block component 1 of a motor vehicle is formed by injection molding and has a plurality of locking receptacles 9 with inner cavities on its top surface and/or the top surface of an associated subcomponent, as some examples only, a cover 3 or housing 5. Locking retainers 7 are snap-fitted into corresponding locking receptacles 9 on the fuse block by inserting bases 29 of the locking retainers 7 into the inner cavities of the locking receptacles 9 and applying force inwardly to the distal head of the locking retainers 7 until engagement prongs 41 on the base of corresponding locking retainers 7 have passed the innermost edge of the cavity of each locking receptacle 9. Component 1 is formed to also have upper mounting brackets 13 and a lower mounting bracket 15, each with a latching tang 14, 16, and also a raised surface 17. Locking retainers 7 are retracted toward locking receptacles 9, and mounting brackets 13 and 15 are inserted into corresponding opening in the fender sheet metal with cavities sufficient to accept the mounting brackets. Mounting brackets 13 and 15 are inserted until latching tangs 14, 16 pass the innermost edge of mounting surface 19. So inserted, component 1 is slid downwardly so that latching tangs 14, 16 latch behind the innermost edge of respective mounting surface and the raised surface 17 contacts an opposing portion of the mounting surface. Locking retainers 7 are advanced into the remainder of the openings in which the upper mounting brackets 13 were inserted by application of force to the proximal ends of the locking retainers. The arms 31 of the locking retainers 7 bias inwardly as they contact the inner edge of the openings until the engagement fingers 33 have passed the innermost edge of the mounting surface, at which point the arms 31 return to their original configuration, locking the edge of the mounting surface in engagement gap 37 of each arm 31. So inserted, the locking retainers 7 are prevented from most or all movement outwardly by contact between the engagement shoulder 35 and the outermost edge of the mounting surface and/or by contact between the engagement prongs 41 and the innermost edge of the locking receptacle 9. Locking retainers 7 are prevented from most or all movement outwardly by contact between the engagement fingers 33 and the innermost edge of the mounting surface.

To remove component 1 from the mounting surface, force is applied inwardly to actuating members 39 of the arms 31, thereby decreasing the width of the head 27 until the width of head 31 across engagement fingers 33 is less than the width of the opening, allowing locking retainers 7 to be backed back out of the opening. Once the head of the locking retainer 7 clears the opening, the component 1 may be removed by lifting the component upwardly so that the latching tangs 14, 16 on the mounting brackets 13, 15 no longer engage the innermost surface of the mounting surface, then backing the component away from the surface and thereby accomplishing the removal.

Should the user wish to replace locking retainer 7 after installation in a locking receptacle 9, pressure can be applied to base 29 external to the oblong spaces 40 to reduce the width of the base at the engagement prongs 41, and base 29 can be backed out of the locking receptacle 9. Alternatively, the user may simply clip the locking retainer 7 into separate parts with an appropriate tool, remove the parts, and insert another locking retainer 7.

While the present invention has been particularly shown and described with reference to the foregoing embodiments, it should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements.

What is claimed is:

1. A locking retainer for mounting a component to a surface, comprised of:
a shaft;
a head attached to a distal portion of the shaft, the head comprised of a plurality of arms that extend outwardly from the longitudinal axis of the shaft, each arm comprising an engagement finger and an engagement shoulder that form an engagement gap; and
a base formed at a more proximal portion of the shaft, the base comprised of a plurality of engagement prongs on its lateral sides, wherein the engagement gap of each arm is configured to engage the edges of an opening in the surface and wherein the engagement prongs are configured to engage a locking receptacle on the component.

2. The locking retainer of claim 1, wherein the component is a component of a motor vehicle and the surface is a surface in or on a motor vehicle.

3. The locking retainer of claim 2, wherein the component is an electrical component.

4. The locking retainer of claim 1, 2, or 3, wherein the locking retainer further comprises one or more slots along its longitudinal axis.

5. The locking retainer of claim 4, wherein one of the slots interfaces with a guide ridge on the component.

6. A system for mounting a component to a surface, comprised of:
a component having at least one locking receptacle and at least one mounting bracket with an engagement tang;
a locking retainer inserted into the locking receptacle on the component, the locking retainer having a shaft; a head attached to a distal portion of the shaft and having a plurality of arms that extend outwardly from the longitudinal axis of the shaft, each arm comprising an engagement finger and an engagement shoulder that form an engagement gap; and a base formed at a more proximal portion of the shaft and having a plurality of engagement prongs on its lateral sides; and
a surface with at least one opening configured to accept the mounting bracket and the locking retainer,
whereby the mounting bracket is inserted into the opening in the surface, the component is moved so as to engage the engagement tang with the surface, and the locking receptacle is inserted into the opening so that the edge of the opening is engaged in the engagement gaps of the locking retainer, and whereby the engagement prongs on the locking retainer are engageable with the locking receptacle to prevent removal of the locking retainer from the locking receptacle.

7. The system of claim 4, wherein the component is a motor vehicle component and the surface is a surface in or on a motor vehicle.

8. The system of claim 5, wherein the component is an electrical component.

9. The system of claim 6, 7, or 8, wherein the locking retainer further comprises one or more slots along its longitudinal axis.

10. The locking retainer of claim 9, wherein the component further comprises one or more guide ridges that interface with a respective slot on the locking retainer.

11. A method of mounting a component to a surface, comprised of:
providing a component having at least one locking receptacle and at least one mounting bracket with an engagement tang;
providing a locking retainer that is insertable into the locking receptacle on the component, the locking retainer having a shaft; a head attached to a distal portion of the shaft and having a plurality of arms that extend outwardly from the longitudinal axis of the shaft, each arm comprising an engagement finger and an engagement shoulder that form an engagement gap; and a base formed at a more proximal portion of the shaft and having a plurality of engagement prongs on its lateral sides;
inserting the locking retainer into the locking receptacle;
providing a surface with at least one opening configured to accept the mounting bracket and the locking retainer;
inserting the mounting bracket into the opening in the surface;
moving the component so as to engage the engagement tang with the innermost side of the surface; and
advancing the locking retainer into the opening until the edge of the opening is engaged in the engagement gap of the locking retainer, wherein the engagement prongs on the locking retainer are engageable with the locking receptacle to prevent removal of the locking retainer from the locking receptacle.

12. The method of claim 11, wherein the component is a motor vehicle component and the surface is a surface in or on a motor vehicle.

13. The method of claim 12, wherein the component is an electrical component.

14. The method of claim 11, 12, or 13, wherein the locking retainer further comprises one or more slots along its longitudinal axis.

15. The method of claim 14, wherein the component further comprises one or more guide ridges that interface with a respective slot on the locking retainer.
